(19) United States
(12) Patent Application Publication
(10) Pub. No.: US 2015/0326742 A1
(43) Pub. Date: Nov. 12, 2015

(54) IMAGE EDITING APPARATUS AND IMAGE EDITING METHOD

(71) Applicant: SHARP KABUSHIKI KAISHA, Osaka (JP)

(72) Inventors: Kumiko OGINO, Osaka (JP); Shinsaku TOHKI, Osaka (JP)

(73) Assignee: SHARP KABUSHIKI KAISHA, Osaka (JP)

(21) Appl. No.: 14/803,937

(22) Filed: Jul. 20, 2015

Related U.S. Application Data
(63) Continuation of application No. 13/236,794, filed on Sep. 20, 2011.

(30) Foreign Application Priority Data
Sep. 22, 2010 (JP) 2010-212175

(51) Int. Cl. H04N 1/00; G06F 3/0488; G06F 3/0485; G06F 3/0481; G06F 3/0482

(52) U.S. Cl. CPC H04N 1/00448; G06F 3/04817; G06F 3/0482; G06F 3/0485; G06F 3/0488; H04N 1/00453; H04N 1/00458; H04N 2201/0094

(57) ABSTRACT

An image editing apparatus includes a display device, a storage device for storing image data, and a preview display unit for displaying a preview image of the image data on a display screen. The preview display unit displays a scroll bar as a UI component for scrolling the preview image, on the display screen. When the image is scrolled, the scroll bar is changed to an enlarged scroll bar. On the screen image, a page jump button and a page number are additionally displayed.

### CROSS-REFERENCE TO RELATED APPLICATION

This application is a Continuation of copending application Ser. No. 13/236,794, filed on Sep. 20, 2011, which claims priority under 35 U.S.C. §119(a) to Patent Application No. 2010-212175 filed in Japan on Sep. 22, 2010, all of which are hereby expressly incorporated by reference into the present application.

### BACKGROUND OF THE INVENTION

1. Field of the Invention

The present invention relates to an image editing apparatus. More specifically, the present invention relates to an image editing apparatus improving visibility and operability of user interface component related to image edition.

2. Description of the Background Art

Recently, multifunctional peripherals as one type of image editing apparatus are introduced to many places of business (companies and offices). A multifunctional peripheral has a plurality of basic operational modes such as a copy mode, a facsimile mode, a network-supported printer mode and a scanner mode. Such a multifunctional peripheral is often provided with a touch-panel display. It is possible for a user to confirm and edit image data on the display. The user can operate the touch-panel while viewing displayed screen images. The multifunctional peripheral additionally has various functions such as storage of image data and preview display. It is often the case that the user also uses the operation panel to give instructions related to these functions. Therefore, an interface screen image of the image editing apparatus comes to play more important role.

When such an image editing apparatus is used, the user often carries out the image data confirmation and editing operations on one display. Therefore, it is necessary to reduce as much as possible the items displayed on the interface screen image, so that the user visibility improves. Since the user carries out the editing operation while directly touching the display, it is desirable that the user interface (UI) components have high operability.

As regards the visibility and operability, Japanese Patent Laying-Open No. 2006-72489 discloses a technique of displaying groups of buttons in enlargement, when a function button is touched. According to this technique, a group of buttons related to the button touched by the user is displayed in enlarged size, while other groups of buttons are displayed in visible but small size. Thus, it becomes easier for the user to confirm and operate the buttons displayed in enlargement.

According to the technique disclosed in Japanese Patent Laying-Open No. 2006-72489, however, when a group of buttons is displayed in enlargement, other portions are displayed only in small size on the screen image. Therefore, if it becomes necessary to operate a button other than the enlarged buttons, operability would be low. Further, when a user operates a group of buttons, it is rather rare for the user to continuously operate buttons of the same type. Therefore, the conventional technique needs improvement in visibility and operability of UI components.

### SUMMARY OF THE INVENTION

In view of the problem above, it is desirable to provide an image editing apparatus that can improve visibility and operability of UI components while making full use of the change in manner of display of the UI components related to image edition.

According to an aspect, the present invention provides an image editing apparatus, including: a display device having a display screen; a storage unit configured to store image data; and a preview display unit configured to display a preview image of the image data stored in the storage unit on the display screen. The preview display unit displays, when the preview image of the image data cannot fully be displayed on the display screen, a user interface (UI) component configured to allow the user operation to scroll the preview image displayed on the display screen, on a first area of the display screen. The image editing apparatus further includes: a scroll unit configured to control the preview display unit such that the image data displayed on the display screen is scrolled in response to an operation of the UI component. The image editing apparatus further includes a display manner changing unit configured to change a first manner of display of the UI component displayed on the display screen to a second manner of display occupying a second area larger than the first area of the display screen, in response to an operation of the UI component.

When the user scrolls the preview image, the manner of display of the UI components changes to the second manner of display, which is larger than the first manner of display. The user can clearly see and recognize the UI component or components to be operated for scrolling. Since the UI component to be operated is displayed to occupy a large area, the user can more easily operate the UI component.

Preferably, the second area encompasses the first area.

Even when the manner of display of the UI components changes from the first to the second manner of display, the position of display is unchanged. Since the manner of display changes on the same place, the change can easily be noticed by the user, and change in the line of sight or change of operation position is unnecessary.

Preferably, the image editing apparatus further includes a display manner returning unit configured to return the manner of display of the UI component to the first manner of display, if a prescribed time period passes without any operation on the UI component.

In the absence of any user operation of scrolling the image for a prescribed time period, the UI components are returned to the first manner of display. If the user is to make an operation other than scrolling, the manner of display of the UI components is the first manner of display, and the components are displayed in the first area of relatively small size. Therefore, display other than the UI components related to scrolling can be enlarged, and visibility of the screen image improves.

Preferably, the UI component includes a scroll bar displayed in a prescribed size on the first display area in the first manner of display. The UI component further includes a scroll bar displayed larger than the prescribed size on the second display area in the second manner of display.

As the UI component for operating image data, a scroll bar is displayed. The second manner of display of the scroll bar is larger than the first manner of display, and hence, the user can easily operate the scroll bar.

More preferably, the UI component includes, in addition to the scroll bar, a button causing the preview image to jump to a prescribed page, displayed on the second display area close to the scroll bar, in the second manner of display.

In the second manner of display, the button for moving the preview image is displayed close to the enlarged scroll bar. By operating this button, it is possible for the user to scroll the preview image faster.

Preferably, the UI component includes a scroll bar displayed in a prescribed size on the first display area in the first manner of display. The UI component further includes, in addition to the scroll bar, a button causing the preview image to jump to a prescribed page, displayed on the second display area close to the scroll bar in the second manner of display.

In the second manner of display, a button causing the preview image to jump to a prescribed page is also displayed, together with the scroll bar. The user can scroll the preview image by operating either one of the scroll bar and the button.

More preferably, the button includes a jump-to-head button for jumping to the head page of the image data, and a jump-to-last button for jumping to the last page of the image data.

When the user presses the jump-to-head button or jump-to-last button, preview of the head page or last page of image data is displayed. Therefore, the user can easily cause the preview image to jump to the head or last page.

Preferably, the image editing apparatus further includes a page number display unit configured to additionally display a page number to each page of the image data displayed on the display screen by the preview display unit, in the second manner of display.

When the user scrolls the preview image, page numbers are additionally displayed on respective pages of the image data. Referring to the page number, the user can easily recognize which page of the overall image data is previewed.

According to another aspect, the present invention provides a method of editing an image displayed on a display screen of a display device, including the steps of storing image data; and displaying a preview image of the image data stored at the storing step on the display screen. At the step of displaying, when the preview image of the image data cannot fully be displayed on the display screen, a user interface (UI) component allowing the user operation to scroll the preview image displayed on the display screen is displayed to occupy a first area of the display screen. The method further includes the steps of controlling the preview display unit such that the image data displayed on the display screen is scrolled, in response to an operation of the UI component; and changing a first manner of display of the UI component displayed on the display screen to a second manner of display occupying a second area larger than the first area of the display screen, in response to an operation of the UI component.

Preferably, the image editing method further includes the step of returning the manner of display of the UI component to the first manner of display, if a prescribed time period passes without any operation on the UI component displayed in the second manner of display.

According to the present invention, as the editing operation starts, display of UI components related to the editing operation changes. Therefore, operation using the UI component or components (for example, scrolling) thereafter becomes easier. Since scrolling is often done continuously, visibility and operability of UI components can be improved while fully utilizing the advantage attained by the change in the manner of display of the UI components.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an appearance of the image editing apparatus in accordance with an embodiment of the present invention.

FIG. 2 schematically shows an internal configuration of the image editing apparatus shown in FIG. 1.

FIG. 3 is a block diagram showing a hardware configuration of the image editing apparatus shown in FIG. 1.

FIG. 4 shows a 1D fit screen image displayed on a touch-panel display.

FIG. 5 shows a 2D screen image displayed on the touch-panel display.

FIG. 6 shows a page flow screen image displayed on the touch-panel display.

FIG. 7 shows that the display of 1D fit screen image of FIG. 4 has been changed.

FIG. 8 shows a control structure of a program executed for returning the image shown in FIG. 7 to the original state.

FIG. 9 shows a control structure of a program executed when the 1D fit screen image is displayed.

FIG. 10 shows a control structure of a program executed when the scroll bar on the 1D fit screen image is operated.

FIG. 11 shows a control structure of a program executed when a preview image on the 1D fit screen image is operated.

### DESCRIPTION OF THE PREFERRED EMBODIMENTS

In the following description, the same components are denoted by the same reference characters. Their names and functions are also the same. Therefore, detailed description thereof will not be repeated.

The image editing apparatus in accordance with the present invention will be described with reference to an image forming apparatus as an example. The image editing apparatus in accordance with the present invention may be an image editing apparatus other than such an image forming apparatus. The image editing apparatus in accordance with the present embodiment may be any apparatus having a plurality of operational modes and provided with an operation console displaying operation selection buttons on a touch-panel display allowing the user to appropriately select an operational mode without confusion, even if the buttons for selecting the operational mode are changed from hardware buttons to software buttons.

It is assumed that the image editing apparatus in accordance with the present embodiment includes a touch-panel display that can be operated by gesture operations as well as touch operations other than the gesture operations. The image editing apparatus may include a touch-panel display allowing touch operations only.

The image editing apparatus forms an image on a sheet of recording paper by electro-photography. The image editing apparatus includes, as operational modes, copy mode, mail mode, FAX mode, i-FAX mode, shared folder mode, data input mode, FTP mode and desk top mode. In the following, configuration of image editing apparatus 100 will be described referring to the operation in the copy mode as an example.

[Function]

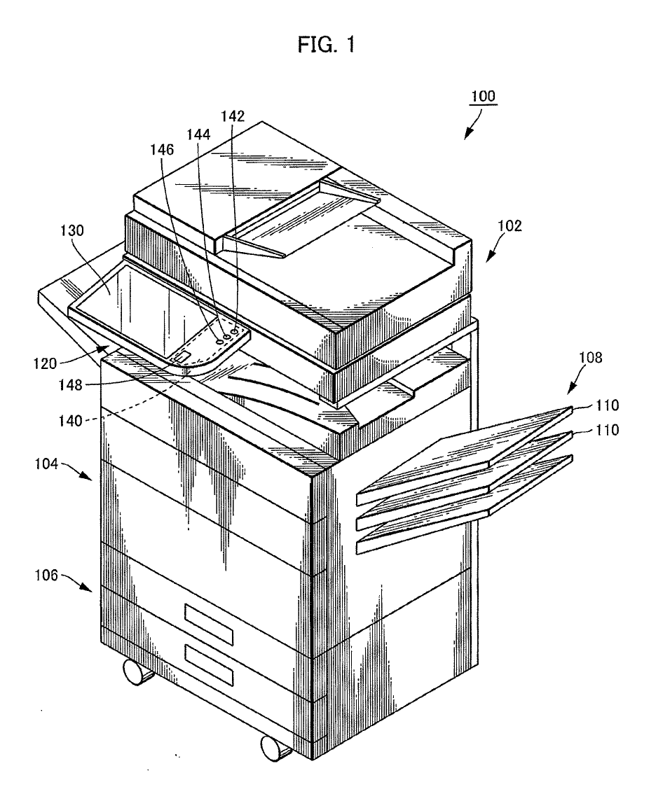

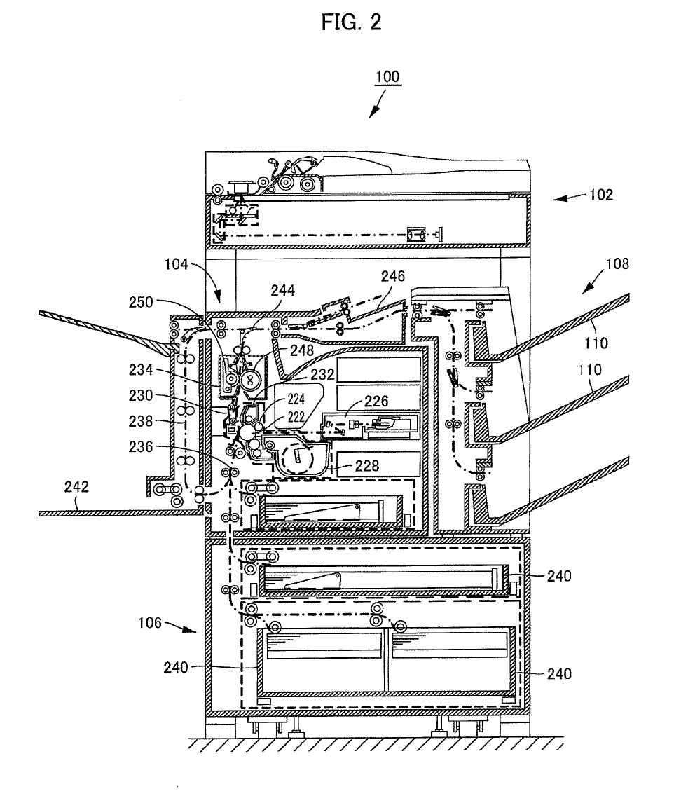

Referring to FIGS. 1 to 3, image editing apparatus 100 includes a document reading unit 102, an image forming unit 104, a paper feed unit 106, a paper discharge unit 108 and an operation unit 120. Operation unit 120 includes a touch-panel display 130 and a display operation unit 140. Touch-panel display 130 includes a display panel 132 formed of a liquid crystal panel or the like, and a touch-panel 134 arranged on display panel 132, which detects a position of a user's finger touching the surface. Display operation unit 140 includes a pilot lamp 142, a power key 144, and an energy-saving key 146. Display operation unit 140 further includes a home key 148 for returning the display screen image of touch-panel display 130 to a home screen image allowing selection of an operational mode.

As described above, image editing apparatus 100 in accordance with the present embodiment is provided with touch-panel display 130 as a main operation device, and, in addition, with display operation unit 140 including hardware keys and a pilot lamp. The keys (power key 144, energy-saving key 146 and home key 148) of display operation unit 140 are hardware buttons, different from the software buttons realized by touch-panel display 130. Image editing apparatus 100 is not limited to those having display operation unit 140 of such a configuration. By way of example, it may be provided only with touch-panel display 130. Image editing apparatus may be any apparatus provided that when the user selects an operational mode using the home screen image displayed on touch-panel display 130, the display is switched to an initial screen image of the selected operational mode. The operational modes of image editing apparatus 100 as such will be described.

Copy Mode

In the following, an operation in the copy mode will be described. In the copy mode, mainly document reading unit (also referred to as a scanner unit) 102 and image forming unit 104 operate.

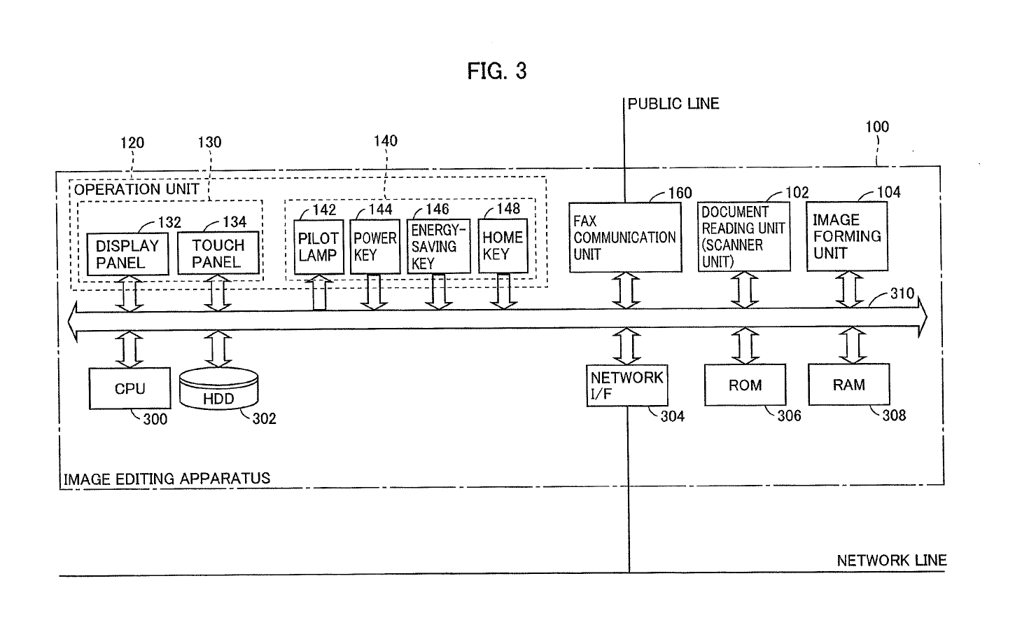

In image editing apparatus 100, a document placed on a platen is read by document reading unit 102 as image data. The read image data is input to CPU (Central Processing Unit) 300 implemented, for example, by a microcomputer shown in FIG. 3. The image data is subjected to various image processing operations here, and the resulting image data is output to image forming unit 104.

Image forming unit 104 is for printing an image of the document represented by the image data on a recording medium (in most cases, on a sheet of recording paper). Image forming unit 104 includes a photoreceptor drum 222, a charger 224, a laser scanning unit (hereinafter denoted as LSU) 226, a developer 228, a transfer device 230, a cleaning device 232, a fixing device 234 and a neutralizer, not shown.

In image forming unit 104, a main feeding path 236 and a reverse feeding path 238 are provided, and a sheet of recording paper fed from paper feed unit 106 is fed along main feeding path 236. Paper feed unit 106 draws out sheets of recording paper stacked on a paper feed cassette 240 or on a manual feed tray 242 one by one, and feeds the sheet of paper to main feeding path 236 of image forming unit 104.

While the sheet of recording paper is fed along main feeding path 236 of image forming unit 104, the sheet passes between photoreceptor drum 222 and transfer device 230, and further passes through fixing device 234, whereby printing is done on the sheet of recording paper.

Photoreceptor drum 222 rotates in one direction, and its surface is cleaned by cleaning device 232 and the neutralizer and, thereafter, uniformly charged by charger 224.

LSU 226 modulates the laser beam based on the image data to be printed, and repeatedly scans the surface of photoreceptor drum 222 with the modulated laser beam in a main scanning direction, whereby an electrostatic latent image is formed on the surface of photoreceptor drum 222.

Developer 228 develops the electrostatic latent image by supplying toner to the surface of photoreceptor drum 222, and thus, a toner image is formed on the surface of photoreceptor drum 222.

Transfer device 230 transfers the toner image on the surface of photoreceptor drum 222 to the sheet of recording paper passing between transfer device 230 and the photoreceptor drum 222.

Fixing device 234 includes a heating roller 248 and a pressure roller 250. Heating roller 248 is for heating the sheet of recording paper. Pressure roller 250 is for pressing the sheet of recording paper. As the sheet of recording paper is heated by heating roller 248 and pressed by pressure roller 250, the toner image that has been transferred to the sheet of recording paper is fixed on the sheet. A heater is heated by electric power supplied to fixing device 234 and controlled such that temperature of heating roller 248 attains to an appropriate temperature for fixing. When operational mode is changed to the energy saving mode, power supply to the heater is, for example, stopped or reduced.

At a position of connection between main feeding path 236 and reverse feeding path 238, a separation pawl 244 is arranged. When printing is done only on one side of the sheet of recording paper, separation pawl 244 is so positioned that the sheet of recording paper fed from fixing device 234 is guided to paper discharge tray 246 or a paper discharge unit 108.

When printing is done on both sides of the sheet of recording paper, separation pawl 244 is turned to a prescribed direction, so that the sheet of recording paper is guided to reverse feeding path 238. The sheet of recording paper passes through reverse feeding path 238, turned upside-down and again fed to main feeding path 236, and while it is again fed along main feeding path 236, printing is done on its rear surface, and thereafter the sheet is guided to paper discharge tray 246 or to paper discharge unit 108.

The sheet of recording paper printed in the above-described manner is guided to paper discharge tray 246 or to paper discharge unit 108, and discharged to paper discharge tray 246 or to any of paper discharge trays 110 of paper discharge unit 108.

Paper discharge unit 108 may perform a process of sorting a plurality of printed sheets of paper to be output to different discharge trays 110, a process of punching each sheet of recording paper or a process of stapling the sheets of recording paper. Assume that a number of copies of the printing are to be prepared. In that case, sheets of recording paper are sorted and discharged to paper discharge trays 110 such that each tray 110 contains each set of printed sheets, and the set of printed sheets in each tray 110 is stapled or punched.

Facsimile Mode

In the following, an operation in the facsimile mode will be described. In the facsimile mode, the facsimile function is realized by transmission and reception operations. In the transmission operation, document reading unit (scanner unit) 102 and FAX communication unit 160 mainly operate. In the reception operation, FAX communication unit 160 and image forming unit 104 mainly operate.

Transmission Operation

In image editing apparatus 100, the facsimile mode is designated. A document placed on the platen is read by document reading unit 102 as image data. The read image data is input to CPU 300 implemented, for example, by a microcomputer shown in FIG. 3, the image data is subjected to various image processing operations here, and the resulting image data is output to a FAX communication unit (FAX communication unit 160 of FIG. 3).

FAX communication unit 160 of image editing apparatus 100 on the transmitting side connects a designated transmitting side line to a designated transmission destination. After connection, FAX communication unit 160 converts the image data to communication data in compliance with facsimile transmission standard, and transmits the converted data to a facsimile machine (such as an image forming apparatus having the facsimile function) on the receiving side.

Communication Operation

When the line is connected, a FAX communication unit of the image forming apparatus on the receiving side detects a communication request signal from FAX communication unit 160 of image editing apparatus 100 on the transmitting side, and transmits an acknowledgement signal. Thereafter, by way of example, FAX communication units on the transmitting and receiving sides pass performance information supported by transmitting side and receiving side, determine highest possible speed of communication and method of coding/code correction of image data, and set the method of communication of modems. Then, using the image signal format in compliance with the communication method, data is transmitted from FAX communication unit 160 of image editing apparatus 100 on the transmitting side to the FAX communication unit of image forming apparatus on the receiving side. When transmission ends, the line is disconnected.

Reception Operation

When image editing apparatus 100 is on the receiving side, FAX communication unit 160 converts the received data to image data and passes the data to image forming unit 104. The received data may be converted to image data at the image forming unit 104. The image forming unit 104 prints an image of a document represented by the image data converted from the received data on a sheet of recording paper, in a manner similar to the operation in the copy mode described above.

Other Image Transmission Mode

Operations of the image editing apparatus in mail mode, i-FAX mode, shared folder mode, data input mode, FTP mode and desk top mode, as image transmission modes other than the facsimile mode, will be described. In these image transmission modes, mainly the document reading unit (scanner unit) 102, image forming unit 104 and network interface (I/F) 304 operate. The operation in the i-FAX mode will be described in the following.

A document placed on a platen is read by document reading unit 102 as image data. The read image data is input to CPU 300, and subjected to various image processing operations here. The image data is stored in a storage device (hard disk 302 as will be described later) provided in image editing apparatus 100. The image data is converted to a format (for example, TIFF-F format) usable for i-FAX. The converted data file is attached to an electronic mail. The electronic mail is transmitted to another image editing apparatus or to a computer through network interface 304 and the Internet.

The image editing apparatus receiving the i-FAX connects to a mail server at a predetermined time interval, and receives any mail addressed to it, stored in the mail server.

Different from the facsimile mode in which a telephone number of transmission destination is designated, a mail address of the transmission destination, an IP address, name of a server computer, a folder name or the like is designated in the image transmission modes other than the facsimile mode.

[Control Block Configuration]

Referring to FIG. 3, image editing apparatus 100 includes an operation unit 120 capable of setting functions related to the copy mode, facsimile mode, document filing mode and mail mode. Image editing apparatus 100 includes an ROM 306 for storing a program or programs, a hard disk (HDD) 302 as a non-volatile storage device capable of storing programs and data even when power is cut off, and an RAM (Random Access Memory) 308 providing a storage area when a program is executed.

Image editing apparatus 100 includes a bus 310, connected to document reading unit 102, image forming unit 104, FAX communication unit 160, operation unit 120, ROM 306, hard disk 302 and RAM 308; and a CPU 300 connected to bus 310, for executing a program realizing general functions of the image editing apparatus.

Hard disk 302 stores files of image data of documents scanned by image editing apparatus 100, folder by folder, together with date and time of saving and name of the user who saved. Hard disk 302 also stores initial screen image data of respective operational modes.

ROM 306 stores programs and data necessary for controlling operations of image editing apparatus 100. ROM 306 may store the initial screen image data of respective operational modes. CPU 300 executes control related to various functions of image editing apparatus 100 in accordance with the programs and data stored in ROM 306.

As shown in FIG. 3, a public line is connected for transmitting/receiving image data, to FAX communication unit 160. To network interface 304, a network line is connected. To the network line, a computer using image editing apparatus 100 as a network-supported printer, other computer or other image editing apparatus may be connected. When the network line is connected to the Internet, image editing apparatus 100 may obtain necessary information and transmit/receive image data through the Internet.

RAM 308 provides a function of a working memory for temporarily storing results of operations and processes by CPU 300, and a function of a frame memory for storing image data.

CPU 300 controls document reading unit 102, image forming unit 104, touch-panel display 130 and display operation unit 140 forming operation unit 120, ROM 306, hard disk 302 and RAM 308 by executing a prescribed program or programs. Operation unit 120 communicates with CPU 300 through an input/output interface.

Operation unit 120 is formed of a plate-shaped panel provided in an inclined manner to be easily viewable by the user. On a surface of operation unit 120, display 130 is provided on the left side area, and display operation unit 140 (pilot lamp 142 and power key 144, energy-saving key 146 and home key 148 as hardware buttons) is provided on the right side area. Display 130 and display operation unit 140 form operation unit 120 as one integrated body as a whole.

As described above, touch-panel display 130 is formed of display panel 132 and touch-panel 134 arranged on display panel 132. On display panel 132 of touch-panel display 130, a home screen image allowing selection of an operational mode of image editing apparatus 100, current state of image editing apparatus 100, status of destination designation, and status of job processing are displayed. On a display area of display panel 132, selection buttons as software buttons are displayed. When a portion where the selection button is displayed is pressed, the pressed position is detected by the touch-panel 134. By comparing the display position of the selection button and the position where the touch-panel 134 is pressed using a program, selection of an operational mode, setting of a function, and instruction of an operation of image editing apparatus 100 become possible. In addition to such a touch operation (command input operation based on the position of pressing by the user), image editing apparatus 100 also allows gesture operation (command input operation based on trajectory of operation by the user).

Pilot lamp 142 of display operation unit 140 may include, for example, an LED (Light Emitting Diode). It is turned on/off (/flickered) under the control of CPU 300. When the user presses power key 144 provided separate from a main power switch, image editing apparatus 100 makes a transition from a standby mode to a normal mode. In the standby mode, only the FAX receiving operation is possible with the main power on. When switched to the normal mode, the user can use every operational mode of image editing apparatus 100. In this state, pilot lamp 142 is turned and kept on. If a predetermined time passes without any user operation, or if the user presses energy-saving key 146, image editing apparatus 100 makes a transition from the normal mode to the energy saving mode. In the energy saving mode, only some of the operational modes of image editing apparatus 100 can be used. In this state, pilot lamp 142 flickers. Further, if the user presses energy-saving key 146 in the energy saving mode, the image editing apparatus 100 makes a transition from the energy saving mode to the normal mode. Home key 148 is a hardware key for returning the display of touch-panel display 130 to the initial state (home screen image).

In a hardware button (power key 144, energy-saving key 146 and home key 148) of display operation unit 140, a key lamp or key lamps, which is/are turned on/off (/flickered) under the control of CPU 300, may be embedded. By way of example, the key lamps provide a light ring on the edge of a circular key, or the key lamp lights a central portion of the key. The key lamp is turned on at a timing when hardware buttons are allowed to be used as the operation device (at a timing when a process is executed if the hardware button is used).

[Image Edition Mode in Preview Display]

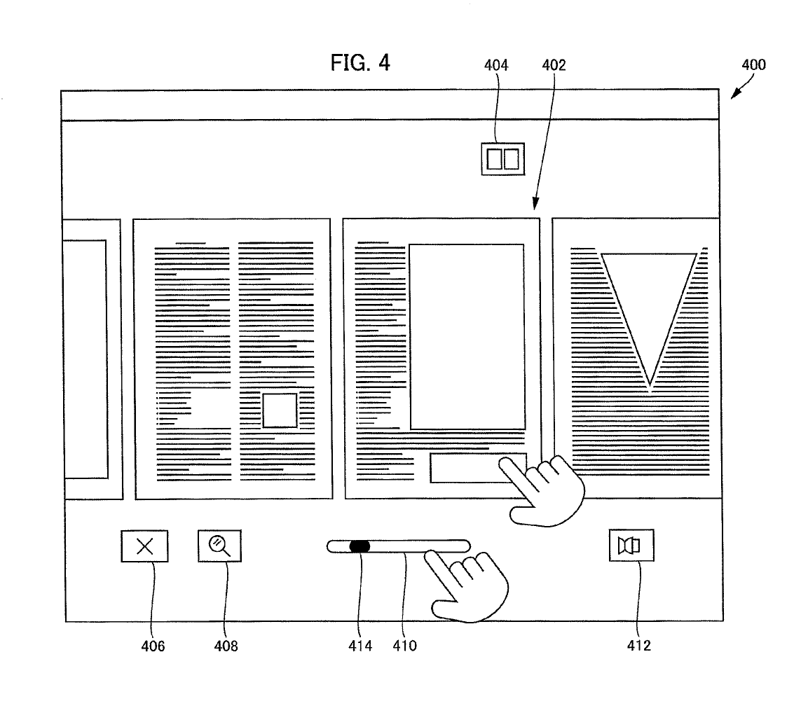

Image editing apparatus has a finish confirmation mode and an edition mode. Display screen image of the preview display changes for the different display modes. Referring to FIGS. 4 to 6, the display screen images for the respective display modes and various UI components will be described.

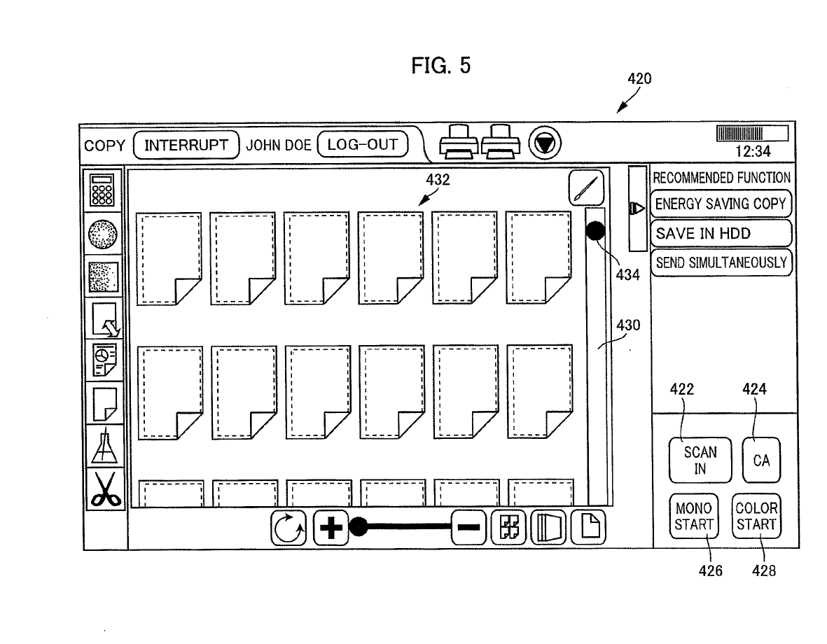

On a lower right portion of the screen image, function keys related to reading and printing are displayed. When a document is set on a platen, not shown, and the user touches a scan start key 422 shown in FIG. 5, document reading unit 102 reads the document, and preview display of the image data of the document appears. When the user touches a monochrome print key 426, monochrome printing of the image data starts. When the user touches a color print key 428, color printing of the image data starts. If the user touches a cancel key 424 during execution of reading and printing, the process being executed is stopped. An area in which scan start key 422, cancel key 424, monochrome print key 426 and color print key 428 are displayed is referred to as a “task trigger area.” The task trigger area is displayed at the same position in any mode.

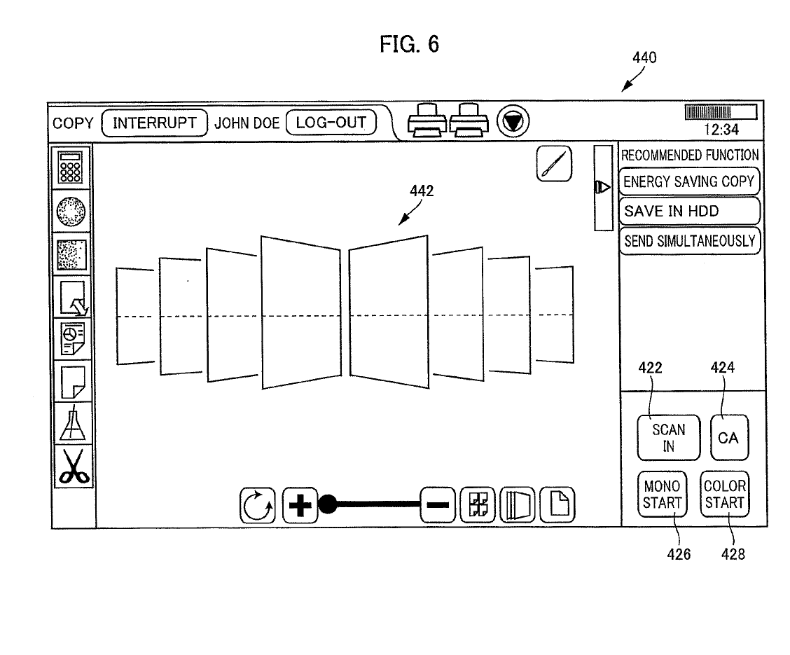

In the finish confirmation mode, the user can confirm in what form the image data will be output. In the finish confirmation mode, the display screen image may assume the display manner of 1D fit screen image shown in FIG. 4, a 2D screen image shown in FIG. 5, or a page flow screen image shown in FIG. 6. In the edition mode, the user can edit image data. In the edition mode, the display screen image assumes the display manner of 1D fit screen image shown in FIG. 4.

Referring to FIG. 4, on 1D fit screen image 400, various function keys are displayed, in addition to the preview display of image data. The user can edit the image data of which preview display is given, using these function keys. If the user touches an all-select/clear key 404, all pages of the preview display screen image of displayed image data are selected. If selection of all pages is to be cancelled, the user may again touch all-select/clear key 404. By dragging a page to be deleted to a page delete key 406, the user can delete the page. The user can also delete the page by selecting page image to be deleted and further by touching page delete key 406. By touching a magnification change key 408, the user can change the display magnification of preview display 402. By operating a scroll button 414 in a scroll bar 410, the user can scroll the page image. From the position of scroll button in scroll bar 410, it is possible for the user to recognize around which page of the overall image data the preview display 402 is displaying. When the user touches a display mode switch key 412, the display screen image makes a transition to the 2D screen image shown in FIG. 5, or to the page flow screen image shown in FIG. 6. Therefore, by touching display mode switch key 412, it is possible for the user to quickly switch the display screen image.

Referring to FIG. 5, on 2D screen image 420, pages of image data are arranged in a matrix. By the preview display of respective pages, the user can confirm the overall arrangement of pages. By operating a scroll button 434, the user can scroll the preview image. Since the 2D screen image is for confirming the finish of image data, edition of image data is impossible.

Referring to FIG. 6, on page flow screen image 440, a preview display 442 showing the image data in three-dimensional manner is displayed. Preview display 442 displays the output document reflecting the state of actual print. By flicking preview display 442, the user can change the page image displayed at the central portion to another page image. Since the page flow screen image is for confirming the finish of image data, edition of image data is impossible.

[Change in Display Screen Image in Edition Mode]

Referring to FIG. 4, various function keys are displayed on 1D fit screen image 400. It is desirable that function keys have high user operability and visibility. In the image editing apparatus in accordance with the present embodiment, the appearance of function keys changes as the editing operation starts. Such changes improve operability and visibility of function keys.

On 1D fit screen image 400, preview display 402 of image data is displayed. When the image data is to be edited, the user touches any portion of 1D fit screen image 400. The touched image is displayed in an emphasized manner, to indicate that it has been selected. At this time, if the user operates preview display 402 or scroll bar 410, the display screen image changes in the following manner.

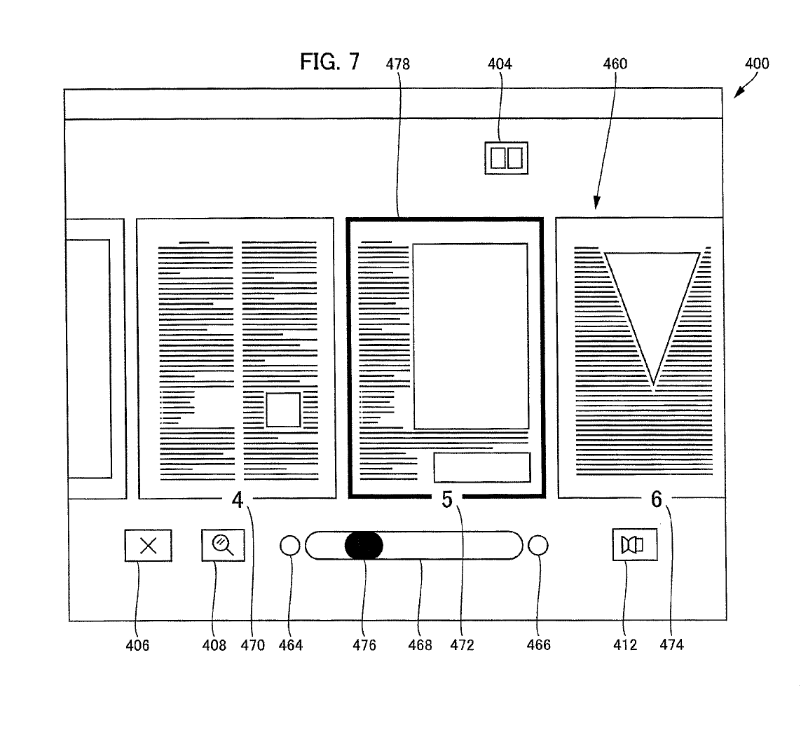

Referring to FIGS. 4 and 7, when the user touches scroll button 414 shown in FIG. 4, scroll bar 410 and scroll button 414 shown in FIG. 4 are enlarged to be an enlarged scroll bar 468 and an enlarged scroll button 476 as shown in FIG. 7. Since the scroll bar is enlarged, it becomes easier for the user to carry out the page moving operation. On opposite ends of enlarged scroll bar 468, a jump-to-head button 464 and a jump-to-last button 466 shown in FIG. 7 are displayed. By touching jump-to-head button 464, the user can have the first page of image data displayed. By touching jump-to-last button 466, the user can have the last page of image data displayed. At a lower portion of each page of preview display 460, page numbers 470, 472 and 474 are displayed. Because of the page number display, it is possible for the user to recognize which page of the image data is currently displayed. The position can roughly be grasped from the position of scroll button 414 and enlarged scroll button 476.

The change in manner of display of keys related to scrolling, and additional display of a function key or keys related to the operated key, such as the enlarged display of scroll bar 410 and scroll button 414 and the display of jump-to-head button 464 and jump-to-last button 466 will be collectively referred to as “display change of function keys” in the present specification.

By touching a portion on scroll bar 410 other than scroll button 414 or by flicking scroll button 414, it is possible for the user to scroll the page image to that page which corresponds to the touched position or corresponds to the length of trajectory and speed of flicking. In this case also, the display of function keys changes on the screen image.

When scroll button 414 is dragged, the page image also scrolls following the movement of scroll button, and the display of function keys is changed. If the user moves the scroll button to a position different from the original position, the page image is scrolled to a page that corresponds to the moved position of scroll button.

Referring to FIGS. 4 and 7, when preview display 402 shown in FIG. 4 is operated, again, the display of function keys changes on the screen image. Similar to the operation on scroll button 414, by flicking preview display 402, the user can scroll the page image. By drag-and-drop of a page position, the user can change the page position. If the destination of drag-and-drop is outside the screen image, the screen image is scrolled by moving the page to be dragged to an end of the screen image of movement destination. When the user touches any of the page images of preview display 402, the touched page is selected as an object of processing and displayed in an emphasized manner. The image displayed with emphasis is, in the present embodiment, surrounded by a frame as represented by display image 478 shown in FIG. 7.

Because of the display change of function keys, it becomes easier for the user to carry out page movement of the image data. Further, since the display screen image other than these portions is not changed, the user can easily recognize the function key or keys to be operated for edition.

If a prescribed time period passes without any operation, the display screen image as changed is returned to the original display screen shown in FIG. 4. Specifically, enlarged scroll bar 468 shown in FIG. 7 is reduced in size and returned to scroll bar 410 shown in FIG. 4. The displays of jump-to-head button 464, jump-to-last button 466 and page numbers 470, 472 and 474 disappear. The timer for counting time lapse is reset every time an operation is made. The prescribed time period is counted from the time point when the user made last operation. The prescribed time period can be set freely by the user.

[Software Configuration]

Referring to FIGS. 4 and 7 to 11, the control structure of the program executed for changing the display screen image in the edition mode will be described.

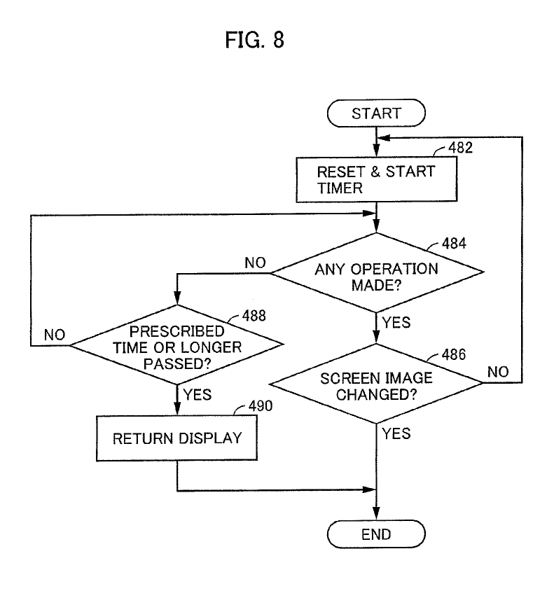

The program shown in FIG. 8 starts when the display change of function keys is executed for the first time. At step 482, CPU 300 resets and starts the timer. At step 484, CPU 300 determines whether any operation has been made on the 1D fit screen image. If the determination is positive, control proceeds to step 486 and, if negative, to step 488. At step 486, CPU 300 determines whether there has been a transition of display screen image made by switching of the display mode. If the determination is positive, execution of the program ends, and if it is negative, control returns to step 482. At step 488, CPU 300 determines whether or not a prescribed time period or longer has passed from the start of the timer. If the determination is positive, control proceeds to step 490, an if it is negative, returns to step 484. At step 490, CPU 300 cancels the display change of function keys, and returns the display screen to the original display shown in FIG. 4. Specifically, the scroll bar and the scroll button return to the original size such as shown in FIG. 4, and the display of page jump buttons and page number disappear.

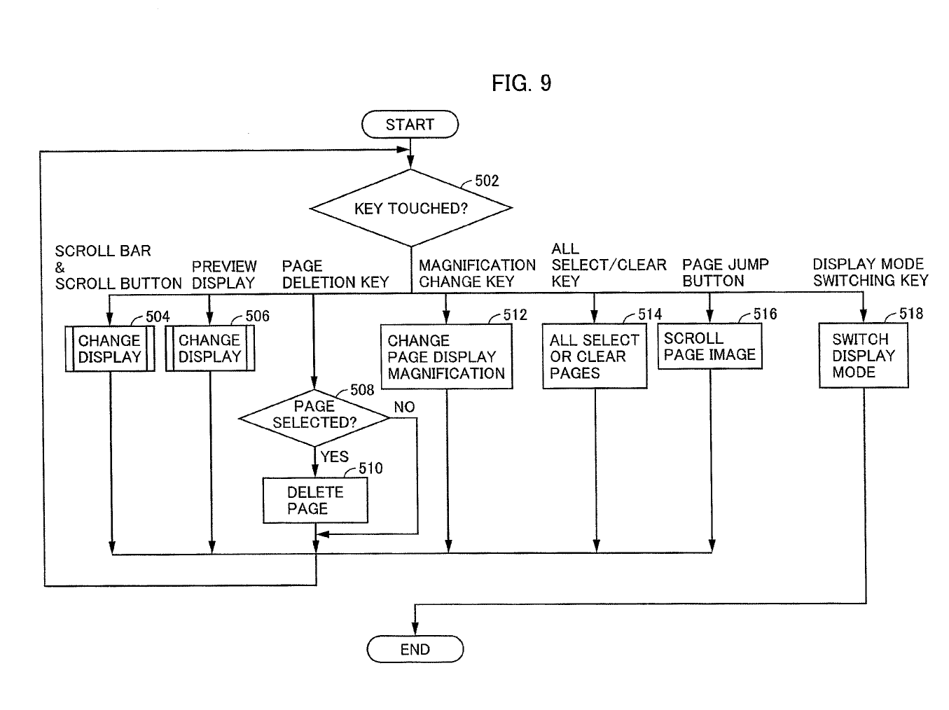

Referring to FIGS. 4, 7 and 9 (particularly FIG. 9), when 1D fit screen image 400 shown in FIG. 4 is displayed, CPU 300 waits until any of the keys is touched. If any of the keys is touched, CPU 300 branches the control flow depending on which key is touched. At step 502, CPU 300 determines which key is touched. The process to be carried out next by CPU 300 differs depending on the result of determination. If the display of function keys is not changed, the program shown in FIG. 8 is activated simultaneously with the touching, no matter which key is touched.

If the user touches scroll bar 410 or scroll button 414 shown in FIG. 4, CPU 300 changes the screen image display (step 504). The control at step 504 will be described in detail later. When the process at step 504 ends, control returns to step 502. When preview display 402 is touched, CPU 300 changes the screen image display (step 506). The control at step 506 will also be described in detail later. When the process at step 506 ends, control returns to step 502.

If page delete key 406 is touched, CPU 300 determines whether or not a page to be deleted has been selected (step 508). If the determination is positive, control proceeds to step 510, and if it is negative, control returns to step 502. At step 510, CPU 300 deletes image data of the selected page. After the end of step 510, control returns to step 502.

If magnification change key 408 shown in FIG. 4 is touched, CPU 300 changes the display magnification of preview display 402 (step 512). At step 512, preview display 402 is enlarged or reduced from the size shown in FIG. 4. When step 512 ends, control returns to step 502.

If all-select/clear key 404 shown in FIG. 4 is touched, CPU 300 selects or clears all page images of preview display 402 (step 514). If there is any page image that is not selected, CPU 300 selects all the page images, and if all pages have already been selected, CPU 300 cancels the selection. The selected page is surrounded by a colored frame, as represented by emphasized display image 478 of FIG. 7. When the process of step 514 ends, control returns to step 502.

If jump-to-head button 464 or jump-to-last button 466 shown in FIG. 7 is touched, CPU 300 scrolls preview display 460 shown in FIG. 7 to the head page or to the last page (step 516). When the process of step 516 ends, control returns to step 502.

If display mode switch key 412 shown in FIG. 4 is touched, CPU 300 switches the display mode (step 518). Therefore, the display screen image makes a transition from 1D fit screen image 400 to 2D screen image 420 shown in FIG. 5, or to page flow screen image 440 shown in FIG. 6. When the process of step 518 ends, execution of the program ends. At the same time, execution of the program shown in FIG. 8 ends.

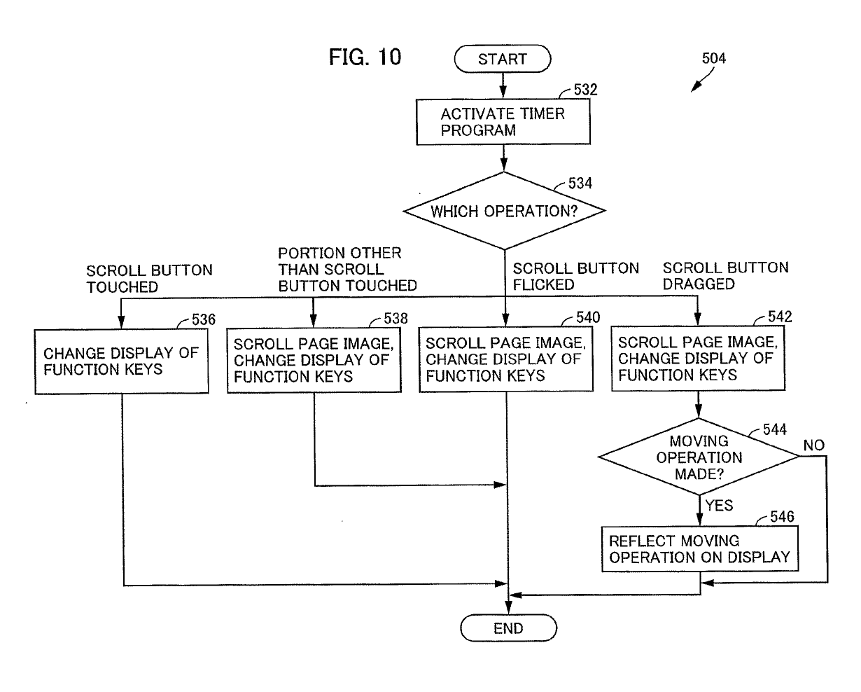

Referring to FIGS. 4 and 10 (mainly FIG. 10), the process at step 504 shown in FIG. 9 will be described in detail. If the user operates scroll bar 410 or scroll button 414 shown in FIG. 4, CPU 300 activates the program shown in FIG. 8 (step 532). If the program has already been activated, it is not accumulatively activated. At step 534, CPU 300 determines what the given operation is, and branches the control flow depending on which key has been pressed.

If scroll button 414 is touched, CPU 300 changes the display of function keys (step 536). When the process of step 536 ends, control of the program ends, and control returns to step 504 of the main routine.

If a portion other than scroll button 414 of scroll bar 410 is touched, CPU 300 scrolls the page image to the page corresponding to the touched portion, and further, changes the display of function keys (step 538). When the process of step 538 ends, execution of the program ends, and control returns to step 504 of the main routine.

If scroll button 414 is flicked, CPU 300 scrolls the page image in accordance with the speed and length of the trajectory formed by the flick, and further, changes the display of function keys (step 540). When the process of step 540 ends, execution of the program ends, and control returns to step 504 of the main routine.

If scroll button 414 is dragged, CPU 300 scrolls the page image and changes the display of function keys, in accordance with the movement of scroll button (step 542). At step 544, CPU 300 determines whether or not the position of scroll button has been changed before and after the operation (step 544). If the determination is positive, control proceeds to step 546, and CPU 300 scrolls the preview display to the page corresponding to the position of scroll button after movement (step 546). When execution of step 546 ends, execution of the program ends, and control returns to step 504 of the main routine. If the determination at step 544 is negative, the preview display is not scrolled, and control immediately returns to step 504 of the main routine.

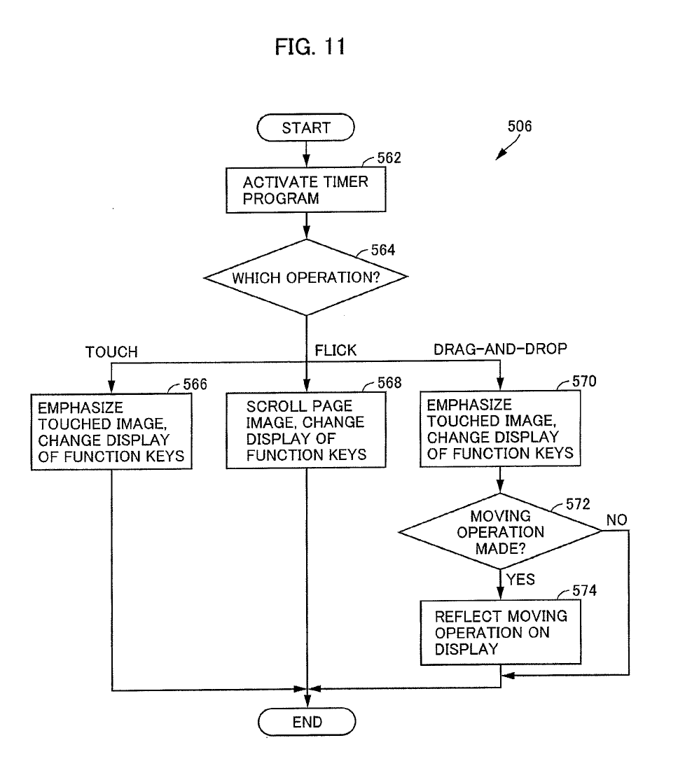

Referring to FIGS. 4 and 11 (mainly FIG. 11), the process at step 506 shown in FIG. 9 will be described in detail. If the user operates preview display 402 shown in FIG. 4, CPU 300 activates the timer program shown in FIG. 8 (step 562). At this time, the program is not activated accumulatively, either. At step 564, CPU 300 determines what type of operation has been made. Further, depending on which key has been touched, CPU 300 branches the control flow.

If preview display 402 is touched, CPU 300 emphasizes the display of touched image, and changes the display of function keys (step 566). The image of emphasized display is surrounded by a colored frame, as can be seen from emphasized image 478 shown in FIG. 7. When the process of step 566 ends, control of the program ends, and control returns to step 506 of the main routine.

If preview display 402 is flicked, CPU 300 scrolls the page image in accordance with the length of trajectory formed by the flick and the speed of flick, and further, changes the display of function keys (step 568). When the process of step 568 ends, control of the program ends, and control returns to step 506 of the main routine.

If any of the page images of preview display 402 is drag-and-dropped, CPU 300 emphasizes the display of operated image, and changes the display of function keys (step 570). At step 572, CPU 300 determines whether or not the operation of moving the selected page image has been done. If the determination is positive, control proceeds to step 574. At step 574, CPU 300 reflects the operation of moving the selected page image on the preview image. When the process of step 574 ends, control returns to step 506 of the main routine. If the determination at step 572 is negative, execution of the program ends immediately, and control returns to step 506 of the main routine.

[Operation]

Referring to FIG. 1, image editing apparatus 100 in the copy mode operates in the following manner. When the user sets a document on a platen of image editing apparatus 100 and touches the scan start key, document reading unit 102 reads the document and generates image data. The input image data is displayed on the 1D fit screen image. While the 1D fit screen image is displayed, the user can edit the image data. When the user touches the print key, the input image data is printed.

Referring to FIG. 4, on 1D fit screen image 400, various function keys are displayed, together with preview display 402 of the image data. If scroll bar 410, scroll button 414 or preview display 402 is touched, display on the screen image changes. Referring to FIG. 7, on the pages of preview display, page numbers 470, 472 and 474 are displayed. Scroll bar 410 and scroll button 414 shown in FIG. 4 are changed to enlarged scroll bar 468 and enlarged scroll button 476 shown in FIG. 7. On opposite ends of enlarged scroll bar 468, jump-to-head button 464 and jump-to-last button 466 are displayed. Because of the enlarged display of scroll bar and scroll button and the display of page jump buttons, the operation of scrolling the page image becomes easier. Since the page number is displayed and the scroll bar is displayed in enlarged size, it is possible for the user to easily confirm around which portion the displayed page image is positioned among the whole image data.

The screen image shown in FIG. 7 returns to the screen image shown in FIG. 4 if a prescribed time period or longer passes from the point of last editing operation by the user. Therefore, enlarged scroll bar 468 and enlarged scroll button 476 shown in FIG. 7 are returned to original scroll bar 410 and original scroll button 414. Page numbers 470, 472 and 474 and page jump buttons 464 and 466 disappear.

If the user executes any of the operations of flicking scroll bar 410, touching scroll bar 410 other than scroll button 414, and dragging scroll button 414, the preview display is scrolled. The preview display is also scrolled if the user flicks preview display 402.

If the preview display 402 is touched, the touched page image is emphasized, as can be seen from emphasized image 478 shown in FIG. 7. If any of the page images of preview display 402 is drag-and-dropped, this moving operation is reflected on preview display 460 and on the image data.

In the embodiment above, the display change occurs only when the scroll bar, scroll button or the preview display is operated. The present invention, however, is not limited to such an embodiment. By way of example, when the scroll bar is touched, the change in screen image may be limited to the enlarged display of scroll bar and scroll button and the display of page jump buttons, and page numbers may not be displayed. When the preview display is touched, the change in screen image may be limited to display of page numbers, and the enlarged display of scroll bar and scroll button and the display of page jump buttons may not be provided. Further, when a function key other than the scroll bar, scroll button and preview display is touched, the scroll bar, scroll button and the function key may be enlarged, and the page number and page jump buttons may be displayed. Only a page deletion key may be displayed in enlargement. As described above, there are many possible combinations of function keys of which appearance may be changed in response to the start of editing operation. Any combination may be used in the image editing apparatus in accordance with the present embodiment.

The scroll bar in accordance with the present embodiment is displayed in enlargement as the editing operation starts. The change in display of the scroll bar is not limited to the enlarged display. By way of example, color of only the scroll bar portion may be changed, or the scroll bar may be flickered. Other function keys may be emphasized in such manners.

When the user touches the preview display in accordance with the present embodiment, the touched page image is surrounded by a colored frame and emphasized. The emphasized display is not limited to such a manner. By way of example, the page image may be flickered, or the page image as a whole may be hatched.

In the image editing apparatus in accordance with the present embodiment, if a prescribed time period or longer passes from the time point of last image edition by the user, the screen image that has been changed returns to the original screen image. The trigger to start the return of screen image is not limited to the passage of prescribed time period. By way of example, the screen image may be returned to the original when the edition mode is switched, or when the edition operation is completed. When the edition mode is switched, the display screen image is switched from the 1D fit screen image to other screen image. If the screen image returns from this changed screen image to the 1D fit screen image again, the preview display and the scroll bar return to the original display before the start of editing operation. Similarly, the display screen image returns to the original state when the editing operation is completed.

In the image editing apparatus of the present embodiment, the manner of display of function keys changes only in the 1D fit screen image. Such a change can also be applied to other display modes. By way of example, the touched function key may be enlarged when the 2D screen image or the page flow screen image is displayed. If any of the page images of preview display is touched by the user, only that page image may be enlarged.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An apparatus, comprising:
a display device having a display screen;
a storage unit storing image data; and
a preview display unit configured to display a preview image of the image data stored in the storage unit on said display screen, wherein
said preview display unit displays a user interface (UI) component allowing a user operation to scroll the preview image displayed on said display screen;
said apparatus further comprising:
a scroll unit configured to control said preview display unit such that said image data displayed on said display screen is scrolled in response to an operation of said UI component; and
a display manner changing unit configured to change a manner of display of said UI component displayed on said display screen, in response to an operation of said preview image.

2. The apparatus according to claim 1, wherein
said preview display unit displays said UI component to occupy a first display area of said display screen;
said display manner changing unit changes a first manner of display of said UI component to a second manner of display occupying a second display area larger than said first area of said display screen; and
said second display area encompasses said first display area.

3. The apparatus according to claim 2, further comprising a display manner returning unit configured to return the manner of display of said UI component to said first manner of display, if a prescribed time period passes without any operation on said UI component displayed in said second manner of display.

4. The apparatus according to claim 3, wherein said UI component includes a scroll bar displayed in a prescribed size on said first display area in said first manner of display, and includes a scroll bar displayed larger than said prescribed size on said second display area in said second manner of display.

5. The apparatus according to claim 4, wherein said UI component includes, in addition to said scroll bar, a button causing the preview image to jump to a prescribed page, displayed on said second display area close to said scroll bar, in said second manner of display.

6. The apparatus according to claim 5, wherein said button includes a jump-to-head button for jumping to the head page of said image data, and a jump-to-last button for jumping to the last page of said image data.

7. The apparatus according to claim 3, wherein said UI component includes a scroll bar displayed in a prescribed size on said first display area in said first manner of display, and includes, in addition to the scroll bar, a button causing the preview image to jump to a prescribed page, displayed on said second display area close to said scroll bar in said second manner of display.

8. The apparatus according to claim 7, further comprising a page number display unit configured to additionally display a page number to each page of said image data displayed on said display screen by said preview display unit, in said second manner of display.

9. The apparatus according to claim 2, further comprising a display manner returning unit configured to return the manner of display of said UI component to said first manner of display, if a prescribed time period passes without any operation on said UI component displayed in said second manner of display.

10. The apparatus according to claim 2, wherein said UI component includes a scroll bar displayed in a prescribed size on said first display area in said first manner of display, and includes a scroll bar displayed larger than said prescribed size on said second display area in said second manner of display.

11. The apparatus according to claim 10, wherein said UI component includes, in addition to said scroll bar, a button causing the preview image to jump to a prescribed page, displayed on said second display area close to said scroll bar, in said second manner of display.

12. The apparatus according to claim 11, wherein said button includes a jump-to-head button for jumping to the head page of said image data, and a jump-to-last button for jumping to the last page of said image data.

13. The apparatus according to claim 2, wherein said UI component includes a scroll bar displayed in a prescribed size on said first display area in said first manner of display, and includes, in addition to the scroll bar, a button causing the preview image to jump to a prescribed page, displayed on said second display area close to said scroll bar in said second manner of display.

14. The apparatus according to claim 13, wherein said button includes a jump-to-head button for jumping to the head page of said image data, and a jump-to-last button for jumping to the last page of said image data.

15. The apparatus according to claim 2, further comprising a page number display unit configured to additionally display a page number to each page of said image data displayed on said display screen by said preview display unit, in said second manner of display.

16. A method of editing an image displayed on a display screen of a display device, comprising the steps of:
storing image data; and
displaying a preview image of the image data stored at said storing step on said display screen; wherein
at said step of displaying, a user interface (UI) component allowing a user operation to scroll the preview image displayed on said display screen is displayed;
said method further comprising the steps of:
controlling display of said display device such that said image data displayed on said display screen is scrolled, in response to an operation of said UI component; and
changing a manner of display of said UI component displayed on said display screen, in response to an operation of said preview image.

17. The image editing method according to claim 16, wherein
said step of displaying includes a step of displaying said UI component to occupy a first display area of said display screen;
said step of changing a manner of display includes a step of changing a first manner of display of said UI component to a second manner of display occupying a second display area larger than said first area of said display screen; and
said second area encompasses said first area.

18. The image editing method according to claim 17, further comprising the step of returning the manner of display of said UI component to said first manner of display, if a prescribed time period passes without any operation on said UI component displayed in said second manner of display.

19. The image editing method according to claim 17, wherein said UI component includes a scroll bar displayed in a prescribed size on said first display area in said first manner of display, and includes a scroll bar displayed larger than said prescribed size on said second display area in said second manner of display.

20. The image editing method according to claim 17, wherein said UI component includes a scroll bar displayed in a prescribed size on said first display area in said first manner of display, and includes, in addition to the scroll bar, a button causing the preview image to jump to a prescribed page, displayed on said second display area close to said scroll bar in said second manner of display.
